(19) United States
(12) Patent Application Publication
(10) Pub. No.: US 2008/0144945 A1
(43) Pub. Date: Jun. 19, 2008

(54) Clusterization of Detected Micro-Calcifications in Digital Mammography Images

(75) Inventors: Nicolas J. Merlet, Jerusalem (IL); Philippe Nathan Bamberger, Jerusalem (IL)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Computer Aided Diagnosis Ltd., Jerusalem (IL)

(21) Appl. No.: 11/958,434

(22) Filed: Dec. 18, 2007

Related U.S. Application Data
(60) Provisional application No. 60/875,562, filed on Dec. 19, 2006.

(51) Int. Cl. G06K 9/62

(52) U.S. Cl. 382/225

(57) ABSTRACT

An iterative method for clusterization of objects in a digital image is taught. Recursivity occurs in both a forward and backward direction and connection is tested using a moving reference object. An optimized set of connection laws is used. A method for optimizing the connection laws to be used is also provided.

### CROSS REFERENCE TO RELATED APPLICATION

The present application claims priority rights from U.S. Provisional Application No. 60/875,562, filed Dec. 19, 2006.

### FIELD OF INVENTION

The present invention relates to a method for clustering objects in a digital image, particularly micro-calcifications in digital mammography.

### BACKGROUND OF THE INVENTION

Breast cancer is one of the most common types of cancer afflicting Western society. It is estimated that the spread of the disease has risen in the United States from one in twenty women being afflicted in 1940, to one in eight in 1995. The Center for Disease Control (CDC) estimated that 187,000 new cases of breast cancer were reported during 2004. In the United States, some 41,000 women die from the disease per year. Today, it is accepted that the best way to detect breast cancer in its early stages is by annual mammography screening of women aged 40 and up.

The five-year survival rate for localized breast cancer is 98%. That rate drops to 83% if the cancer has spread regionally by the time of diagnosis. For patients with distant metastases at the time of diagnosis, the five-year survival rate is only 27%. Early diagnosis is thus of great importance. Since the interpretation of mammographic lesions is problematic, a need for advanced diagnostic tools is required.

The main mammographic findings that may indicate breast cancer are:
1. masses and densities
2. micro-calcifications.

The characteristics used to determine whether or not masses are malignant are: a) shape (regularity versus irregularity), b) margins (distinct or non-distinct), c) spiculation (thin lines extending from the mass).

Among the characteristics that distinguish between malignant or benign micro-calcifications are: size, form, pleomorphism within the cluster, cluster shape (if linear or branch-like), spatial density (if crowded or spread out) and relationship to masses.

Certain structural characteristics of individual micro-calcifications and micro-calcification clusters can provide valuable diagnostic information. For example, micro-calcifications that appear much brighter than the surrounding region or have a smooth perimeter, tend to be benign. Other micro-calcifications that appear to have brightness very close to the surrounding region or have highly irregular shape tend to be malignant.

Today, radiologists generally interpret a mammogram visually, using a light box, and their analysis is largely subjective. Film masking is used to highlight additional detail. In many cases, the radiologist employs supplementary tools such as a magnifying glass and bright light sources to evaluate very dark regions. If the mammogram is not conclusive the radiologist must recall the patient for an additional mammogram using one or more of the following techniques:
1. adding a view with a different projection.
2. performing a magnification mammogram by changing the distance between the breast and the film.
3. locally compressing the breast in the area of suspected abnormality.

The analysis, even after using the above techniques, still remains highly subjective.

All the statistical data related to the conventional mammogram process were published in scientific literature and concern the U.S. population only. It is assumed that these data are also relevant outside the U.S.
1. Most professional organizations recommend that women over age 40 have a mammography examination once a year.
2. There is a recall rate of about 20%. This is the percentage of patients recalled to perform further examinations, essentially another mammogram.
3. About 3% of women who are evaluated by screening mammography are referred for a biopsy.
4. In screening mammography, about 60 malignancies are found in a sample of 10,000 cases.
5. The false negative rate of the mammographic screening process is difficult to estimate. It is generally accepted that 15% of the women who have ultimately been diagnosed with breast cancer and who had a mammogram performed during the previous 12 months were not originally diagnosed with cancer. Missed detections may be attributed to several factors including: poor image quality, improper patient positioning, inaccurate interpretation, fibroglandular tissue obscuration, subtle nature of radiographic findings, eye fatigue, or oversight.
6. The false positive rate of the screening mammography process, i.e. the rate of negative results of biopsies performed due to the screening process, is about 80%.

In order to aid radiologists in reducing the false negative rate in mammographic screening, computer systems using specialized software and/or specialized hardware have been developed. These systems, often called computer-aided detection (CAD) systems, have been known for many years and have been reported on extensively. Their use in evaluating mammograms has been discussed at length in both the patent and professional literature and they have been introduced into a growing number of clinical sites.

CAD methods aim at detecting various types of possibly malignant lesions that radiologists look for in mammography images. As noted above, micro-calcification clusters (MCC) is one of these lesion types. Visually, these consist of groups of small (˜1 mm or less) white spots which are sometimes missed by the radiologists due to their small size and/or their low contrast with the background.

The identification of micro-calcifications represents an important goal for automated detection because micro-calcifications are often the first radiographic findings in early, curable breast cancers. Between 60 and 80 percent of breast carcinomas reveal micro-calcifications upon histologic examination. Any increase in the detection rate of micro-calcifications by mammography will lead to improvements in overall breast cancer detection.

CAD systems which detect micro-calcifications (MCs) and micro-calcification clusters (MCCs) can be thought of as going through three stages. In the first stage of the CAD process for the detection of MCCs, individual micro-calcifications (MCs) are detected. Some of these detected MCs may be filtered out as part of this first stage. In a second stage of the CAD process, herein denoted as ‘clusterization’, MCCs are created by grouping together individual MCs using pre-selected rules. In further steps of the process, some of the MCCs are filtered out, others are merged and, finally, detection marks indicating the presence of created MCs are presented to the radiologist. The performance of the overall MCC detection process depends obviously on the quality of all of the steps of the process, among them the clusterization step in stage 2 above.

The above considerations, and the unsatisfactory results obtained with some of the presently available CAD methods, require the development of new procedures suitable for detection of micro-calcifications (MCs) and micro-calcification clusters (MCCs).

### TERMINOLOGY

The following terms may be used interchangeably in the discussion herein without any attempt at distinguishing between them.

Clusterization law and connection law are deemed synonymous and used interchangeably herein.

Digital image, that is a directly obtained digital image, is herein also meant to include a digitized image that is an image obtained from digitizing an analogue image. Digital image and digitized image when used herein are deemed synonymous and will be used interchangeably.

### SUMMARY OF THE INVENTION

It is an object of the present invention to provide a more effective and time-saving method for determining object clusters in digital images, particularly micro-calcification clusters in mammogram digital images.

It is a further object of the invention to provide a method for clustering objects in digital images, particularly micro-calcifications in mammogram digital images, with high sensitivity and specificity.

The present invention provides a method for employing a processing system to create clusters of objects in a digital image. The method comprises the steps of: choosing an initial reference object from a set of available objects in the digital image and removing this object from the set; searching in the set of available objects for a second object that connects to the reference object according to a pre-selected connection law; designating the second object as a new reference object and removing it from the set of available objects; repeating the steps of searching and designating until no connection can be made to any of the remaining available objects in the set or until all objects have been connected; wherein, the step of repeating includes, restoring the immediate previous reference object as the new reference object if no connection can be made to any of the remaining available objects; and iterating the steps of searching, designating, repeating, and restoring until the set of available objects is emptied or until no previous reference object is left to restore, thereby creating a cluster of objects.

In another embodiment of the method, the method further includes the step of creating groups of objects from the set of available objects, each group corresponding to the content of an image cell. The image cells are arranged into square grids with the width of each square being equal to a predefined distance. The step of searching is then limited to searching the group containing the reference object plus its surrounding eight nearest neighbor groups.

In another embodiment of the method for creating clusters, the method further includes the step of selecting another initial reference object. The embodiment also further includes the step of cycling through said steps of searching, designating, repeating, restoring and iterating. The steps of selecting and cycling are repeated until all the groups that have been created are empty of available objects, thereby creating a plurality of clusters for the digital image.

In yet another embodiment of the method, the method further includes the step of adding all clusters formed by the method to a list of clusters.

In still another embodiment of the method, the method further includes displaying the list of clusters on a display of the processing system after the list of clusters has been filtered according to predefined criteria.

In another embodiment of the method for creating clusters, the connection law in the step of searching is based on parameters employing the distance between the reference and second objects and a predefined combination of scores related to both the reference and second objects.

In another embodiment of the method for creating clusters, the connection law only allows for connecting two objects separated by a distance less than or equal to a predefined distance.

In yet another embodiment of the method for creating clusters, the objects are micro-calcifications in a mammographic digital image and the clusters of micro-calcifications formed thereby indicate whether the tissue in the image is diseased.

In another aspect of the present invention there is provided a method for establishing an optimized set of connection laws from a preliminary set of connection laws, the optimized set of connection laws to be used for creating clusters of objects in a digital image. The method includes the steps of: providing a set of objects for each image in a training set of malignant images, each object having associated with it spatial coordinates and a score that is statistically related to the probability of the object being a true object, and for each image in a training set of normal images providing a similar, but separate, set of objects; for each image in the training set of malignant images, providing also a list of the regions containing clusters of known malignant character; creating clusters of the objects in each image according to the method for creating clusters as discussed above and using a connection law from the preliminary set of connection laws and eliminating from consideration any cluster that does not contain a minimal pre-defined number of connected objects; determining the average number of false clusters found in the images of the normal training set and the found and missed malignant clusters in each of the images in the malignant training set; repeating the steps of creating and determining, for each connection law of the preliminary set of connection laws; and selecting an optimized connection law for use in creating clusters of objects in a digital image, the selected optimized connection law providing an appropriate combination of sensitivity and specificity values for use according to the performance requirements of the user.

In yet another embodiment of the method for establishing an optimized set of connection laws there is included a step of graphically summarizing the performance of each connection law as a point in a 2-dimensional space defined by the percentage of malignant clusters in all the images of the malignant training set correctly determined versus the average number of false clusters detected in the normal training set and the step of drawing an envelope of the points corresponding to the results obtained from the entire preliminary set of connection laws in the graphical summary; and wherein the step of selecting an optimized connection law constitutes selecting a connection law on or near the envelope of the points in the graphical summary. In some instances in the step of drawing, the envelope is a convex Hull envelope.

In yet another embodiment of the method for establishing an optimized set of connection laws, in each of the steps of providing, each object of the set of i objects is provided with a score sᵢ, determined using a plurality of image characteristics of object i, and each pair of objects, i and j, is given a pair score Sᵢⱼ based on a predefined combination of their individual scores, sᵢ and sⱼ, and a pair distance dᵢⱼ representing the distance between objects i and j. In some instances, the family of acceptable connection laws is graphically defined in (Sᵢⱼ, dᵢⱼ) space by a broken line such that a pair of objects are connectable when their representation in (Sᵢⱼ,dᵢⱼ) space is located below the broken line and where the broken line is such that: a first segment extends from (0,0) to (S0,0), S0 being a defined minimal threshold for pair score Sᵢⱼ; a second segment goes from (S0,0) to (S1,dmax), S1 being a defined second pair score value and dmax being the distance above which no connection is allowed; and a last infinite segment starting from (S1,dmax) and continuing horizontally toward (∞,dmax).

### BRIEF DESCRIPTION OF THE FIGURES

The invention is herein described, by way of example only, with reference to the accompanying Figures. With specific reference now to the Figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show details of the invention in greater detail than is necessary for a fundamental understanding of the invention, the description taken with the Figures making apparent to those skilled in the art how the several forms of the invention may be embodied in practice.

The present invention will be more fully understood and its features and advantages will become apparent to those skilled in the art by reference to the ensuing description, taken in conjunction with the accompanying Figures, in which:

FIG. 1 shows a flowchart of the general method for clustering objects in a digital image;

FIG. 2 shows an expanded flowchart of the method of the present invention for clustering objects in a digital image;

FIG. 3 shows a flowchart of a method for optimizing the connection law to be used in the method of the present invention shown in FIG. 2;

FIG. 4 is a graph of the performance of the individual connection laws in a set of connection laws in sensitivity versus false cluster space;

FIG. 5 is an envelope of the graph shown in FIG. 4;

FIG. 6 is a graphical representation of the set of connection laws chosen for evaluation, the representation being a function of object pair distance and object pair score; and

FIG. 7 is a schematic presentation of a prior art computer system that may be used with the method of the present invention.

### DETAILED DESCRIPTION OF THE PREFERRED EMBODIMENTS OF THE INVENTION

In what is discussed herein, the objects in digital images will generally be referred to as micro-calcifications (MCs) and the clusters herein as micro-calcification clusters (MCCs). It should readily be understood that the method and techniques discussed herein may be used with other objects found in digital images for which clusterization is required. In such cases, a portion of the available objects are false objects which should ideally be rejected in the clusterization process.

In general, a CAD process used in detecting MCs and MCCs in mammogram digital images needs to employ the same criteria used by radiologists for defining potentially malignant lesions. Therefore, from a CAD perspective, a micro-calcification cluster (MCC) is deemed to consist of an ensemble of MCs in which there is a continuous path of connected MCs linking any two MCs in the MCC. A maximum distance, typically but without intending to limit the invention, of 1 cm is allowed between two connected MCs.

In a conventional mammography reading, a radiologist feels confident of his ability to clearly identify individual MCs. Based on the identified MCs he only needs to evaluate their mutual distances in order to decide on the presence of an MCC.

When using a CAD system, however, MCs are identified with less certainty. The process used to detect individual MCs, not only detects real calcifications, but also generates a large number of false MCs. For this reason, a CAD system can not build MCCs from CAD-detected MCs in the same way that clusters are ‘built’ by radiologists. If similar procedures were used, CAD generated clusters would often result in giant clusters covering a large part of the breast.

In order to overcome this difficulty, criteria, other than the distance criterion, should be used in deciding if two CAD-detected MCs are connected. In the method of the present invention, every CAD-detected MC is assigned a score that reflects its probability of being a true MC. A true MC is one that may be connected to another MC. Obviously, the quality of this score is only approximate since it can not be used to reliably filter out false MCs. Most naturally, the additional criteria used for validating a connection between a pair of MCs will be the score of one or the other of the pair of MCs or a predefined combination of both scores.

Without intending to limit the methods of arriving at a score for each MC, the scores can be arrived at by using one or a weighted combination of the following MC characteristics, also sometimes referred to herein as parameters. These characteristics include (1) brightness, (2) area, (3) length, and (4) shape factor computed according to one or more criteria. This list is exemplary only and is not intended to be exhaustive. These aforementioned characteristics can be individually obtained in many different ways, such as those used in U.S. Pat. Nos. 5,854,851 and 5,970,164 both to P. Bamberger et al, herein incorporated by reference.

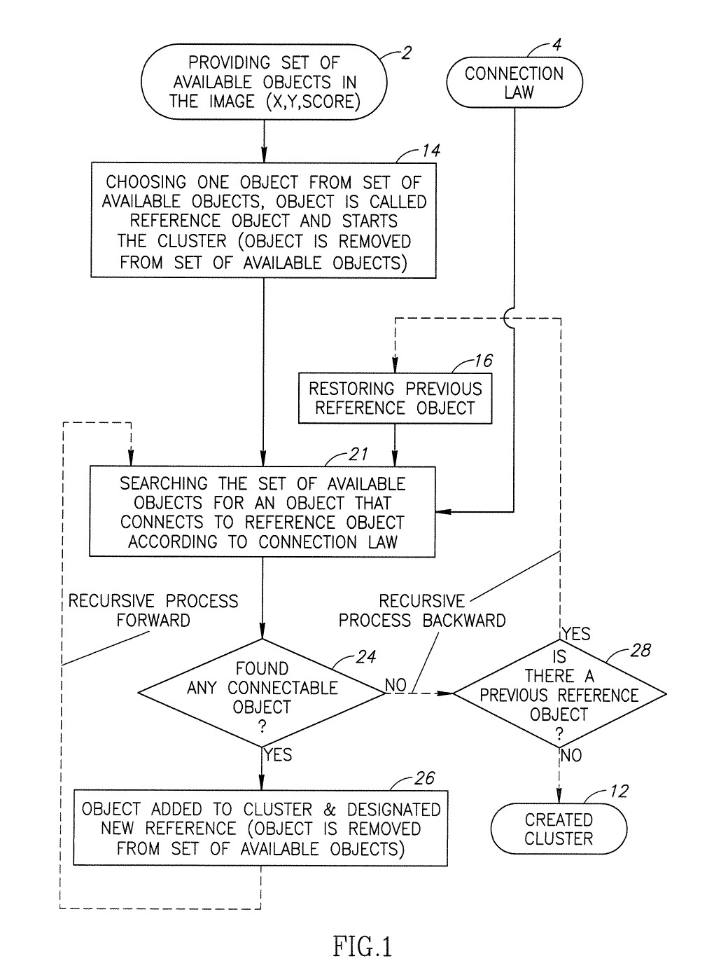

The clusterization method of the present invention discussed in conjunction with FIG. 1 below requires two elements for creating clusters in a given digital image:
a set of the micro-calcifications (MCs) in the digital image, each MC defined by its position (x,y) and its score as discussed above; and
a clusterization law that defines the distance and score conditions required for connecting two MCs.

The main characteristic of the method of the present invention is its recursivity. Once the connection of MC ‘b’ to MC ‘a’ is validated, i.e. once the clusterization law's conditions are met, the method does not look immediately for another MC to connect to ‘a’ but looks for an MC ‘c’ to connect to ‘b’. It will then proceed to look for another MC ‘d’ to connect to ‘c’ and so forth. In FIG. 1 discussed below, this mode of operation is indicated by the arrow labeled ‘recursive process Forward’. It should also be noted that in the Figure, the MC to which we try to connect another MC is always deemed to be the ‘reference’ MC.

Once no MC can be connected to the reference MC, the immediate previous reference MC is retrieved and the process looks for another MC to connect to it. Beginning the whole process from any selected MC, the method eventually returns to the same initial MC, completing the creation of a cluster. In FIG. 1, the part of the method using previous reference MCs is labeled as ‘recursive process Backward’.

FIG. 1 indicates the basic method of clustering objects according to the present invention as outlined above. While FIG. 1 is presented in terms of objects, as noted above it can be applied to the specific case of micro-calcifications.

The method requires providing 2 a set of available objects detected in a digital image, each object being given x, y coordinates and a score. The score is a predefined combination of various object characteristics, such as size, area, brightness, and morphology. They may also include other characteristics not explicitly noted herein.

This is followed by choosing 14 one object from the set of available objects and using it as the initial reference object from which a cluster may be created. The initial reference object is removed from the set of available objects. The step of choosing is typically performed by the processor of a computer system according to a pre-defined method. However, the result of the clusterization process, i.e. the clusters created, does not depend on the method used for choosing the initial reference object and, therefore, the initial reference object may be chosen randomly.

The set of available objects is searched 21 to locate a second object that connects to the reference object. The search uses a predefined connection law 4 to determine if the second object is connectable to the reference object.

If a second object is found 24 in block 21 that is connectable to the reference object using the connection criteria of the predefined connection law 4, this second object is added 26 to the cluster and it is designated as a new reference object. This new reference object is also then removed from the set of available objects provided in block 2 and the process returns to block 21 and cycles through blocks 21, 24 and 26. Returning from block 26 to block 21 constitutes what in FIG. 1 is called the ‘recursive process-Forward’ path.

If in block 24 it appears that no object is found in block 21 that is connectable to the last reference object, the method requires that a decision 28 be made as to the presence of an immediate past reference object. If such an object exists, the immediate past reference object is restored 16 and it becomes the new reference object. This is followed by cycling through blocks 21, 24, and 26 as described previously. Returning from block 24 to block 21 through blocks 28 and 16 constitutes what in FIG. 1 is called the ‘recursive process-Backward’ path.

If in decision block 28 no immediate previous reference object is found, the cluster resulting from the previous steps is deemed 12 a complete created object cluster. While not shown the created cluster may be added to a list of created clusters. The individual objects forming a created object cluster may also be noted in the list of created clusters.

It should readily be evident that the system for clustering includes a processor which carries out the steps of the method. A display element is in electronic communication with the processor as discussed in greater detail below. Once the list of created clusters is complete, the processor may display each listed cluster on a displayed digital image. In some embodiments, this step of displaying may require prior filtering.

An additional important feature of this method is its time optimization. In order to avoid having to check the connectivity between MCs that are clearly too far from each other to fulfill the criteria of the connection law, the image may be initially divided into adjacent cells of a predefined size, for example a grid of 1×1 cm when the distance criterion between connective MCs in the connection law being used is d≦1 cm. For each cell in the grid, the MCs included in the cell are identified and labeled together as a group.

When looking for an MC to connect to a reference MC, only the MCs located in the reference MC's group and in the groups of its eight nearest neighbor cells are considered. MCs located in other cells can not fulfill the basic distance criterion. It should readily be understood by one skilled in the art that the cell sizes and MC distance criteria can be selected to be greater than or less than 1 cm.

In order to avoid reusing the same MC in several clusters, any MC already connected to another MC is removed from the group of available MCs in its cell.

Locating Micro-Calcifications

Prior to applying the method of the present invention, micro-calcifications must first be located in the mammogram digital image. Because micro-calcifications have a higher optical density than ordinary breast tissue, they appear on the mammogram as small regions that are brighter than their surrounding region.

The difference in grey level between a micro-calcification and its surrounding region may often be very small. The processor of a computer system may apply various enhancement features, including, but not limited to, grey scale stretching and high-pass filtration, of the digital image. The image exhibits better contrast as a result of these enhancement features. This assists the processor in identifying suspicious areas on the mammogram digital image as possible micro-calcifications.

As an additional feature useful in identifying micro-calcifications, the processor of the computer system being used determines the grey level value of a given pixel. This allows the system to compare quantitatively the densities of two areas and to identify areas of increased optical density that may not be apparent due to surrounding high density tissue.

In order to eliminate the effect of the background on the appearance of the objects that represent micro-calcifications, the system may automatically apply a background suppression routine, such as a difference of Gaussians (DOG) filter, to the whole digital image. Based on the background suppressed images, the whole image is then trimmed using grey level thresholding. By lowering the threshold, more micro-calcifications can be identified. Conversely, by raising the threshold, fewer micro-calcifications can be identified.

An alternative, or supplementary, method for background suppression proceeds as follows. Since the micro-calcifications appear against a non-uniform background in the image, the system first subtracts the background information from the original digital image. The background information is represented by a secondary image created by smoothing the digital image using a convolution mask. The convolution mask preferably is a square and symmetric matrix filled with “1”s.

The size of the mask is obtained, in pixels, in accordance with the scanning resolution and the average size of micro-calcifications, by using, without intending to limit other approaches to the process, the relationship X (pixels)=0.45 mm×DPI/25.4, where X is the size of the convolution mask for the background suppression routine, in pixels, and DPI is the resolution of the scanning process in dots per inch. This number is divided by 25.4 mm/inch to yield the resolution in dots per millimeter. The 0.45 mm represents the average size of a micro-calcification region. This latter value may vary from case to case and should not be deemed to limit the size of the MC regions.

Additionally, if desired, a rectangular region containing breast tissue may be segmented from the digital mammogram image to decrease the time required for processing the mammogram digital images. A binary mask corresponding to the breast tissue, a “breast mask”, may be created for use in later processing steps. The breast mask limits detection to areas of the image containing breast tissue. Focusing only on the breast tissue reduces the time required to process the image and false positive indications lying outside of the breast tissue area are automatically eliminated. Methods for preparing such breast masks are known to persons skilled in the art.

A binary pectoral mask corresponding to tissue of the pectoral muscle may also be generated. The pectoral mask may be used to suppress detections in the pectoral region. The pectoral mask is a binary mask identifying the location of pectoral muscle tissue in the image. Methods for forming pectoral masks are known in the art. Such a mask is useful to inhibit detections in the pectoral muscle because cancer only infrequently occurs in the pectoral muscle. Furthermore, this portion of the digital mammogram is usually brighter than the other regions, which can cause false positive detections. Thus, inhibiting detections in the pectoral muscle improves the performance of the system of the present invention.

It should be realized by one skilled in the art that other known image processing techniques may also be used to localize MCs. The discussion above is not intended to be a limiting discussion of the image processing operations that may be used.

Once grey level thresholding and/or the other techniques discussed above localize the micro-calcifications, the system performs the “region growing” method for estimating the contour of each localized micro-calcification. The “region growing” method produces an image having spots representing micro-calcifications which closely approximate the contour of the actual micro-calcifications in the breast tissue. The system also calculates various MC structural parameters, also often denoted herein as MC characteristics, associated with individual micro-calcifications. These MC characteristics are then used to calculate a score for each MC used in the connection steps of the present invention as discussed below.

Typical parameters that may be used to characterize each individual micro-calcification are brightness, area, length, shape factor, and any morphological descriptor computed according to one or more criteria. While these are typical parameters others known to those skilled in the art may also be used. As described above predefined combinations of these parameters are used to determine a score for each MC.

The above and other methods for image manipulation which may be used to identify MCs prior to application of the present invention are discussed inter alia in U.S. Pat. Nos. 5,854,851 and 5,970,164 both to Bamberger et al and U.S. Pat. No. 6,763,128 to Rogers et al, all herein incorporated by reference.

Method of Clusterization

After the above preprocessing of the mammogram digital image has been carried out and micro-calcifications have been located, the method of the present invention for forming micro-calcification clusters may be applied.

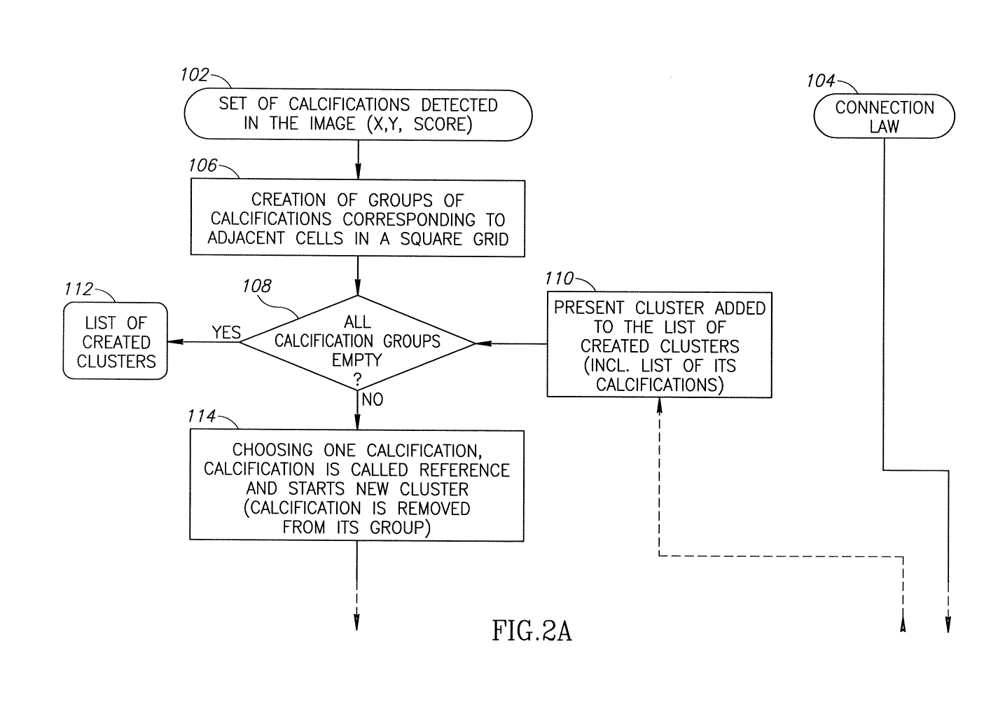

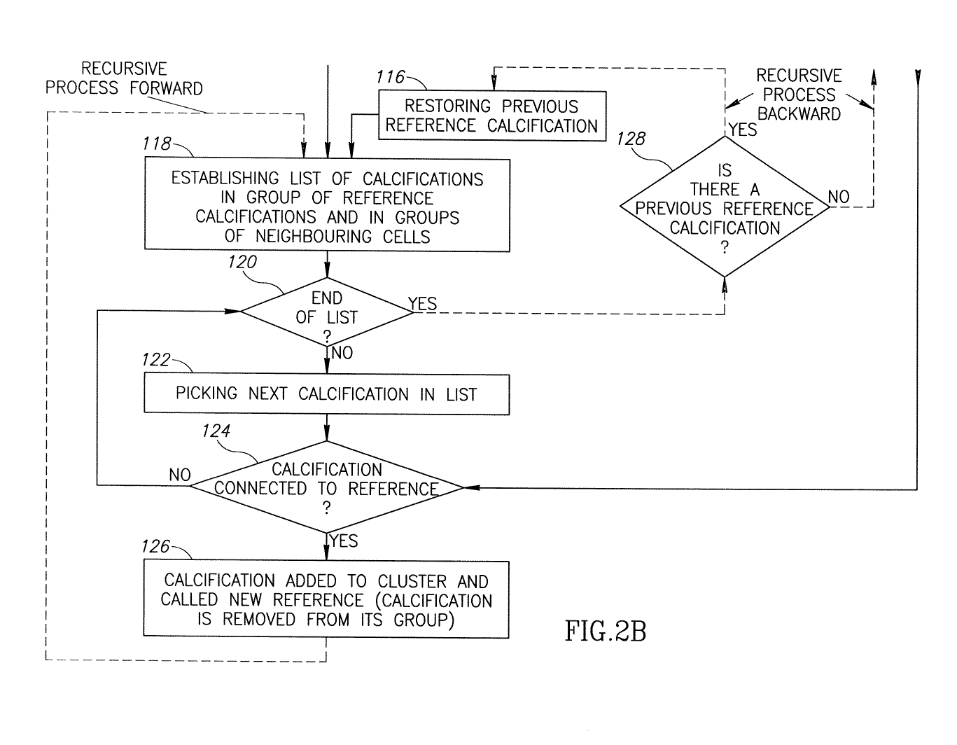

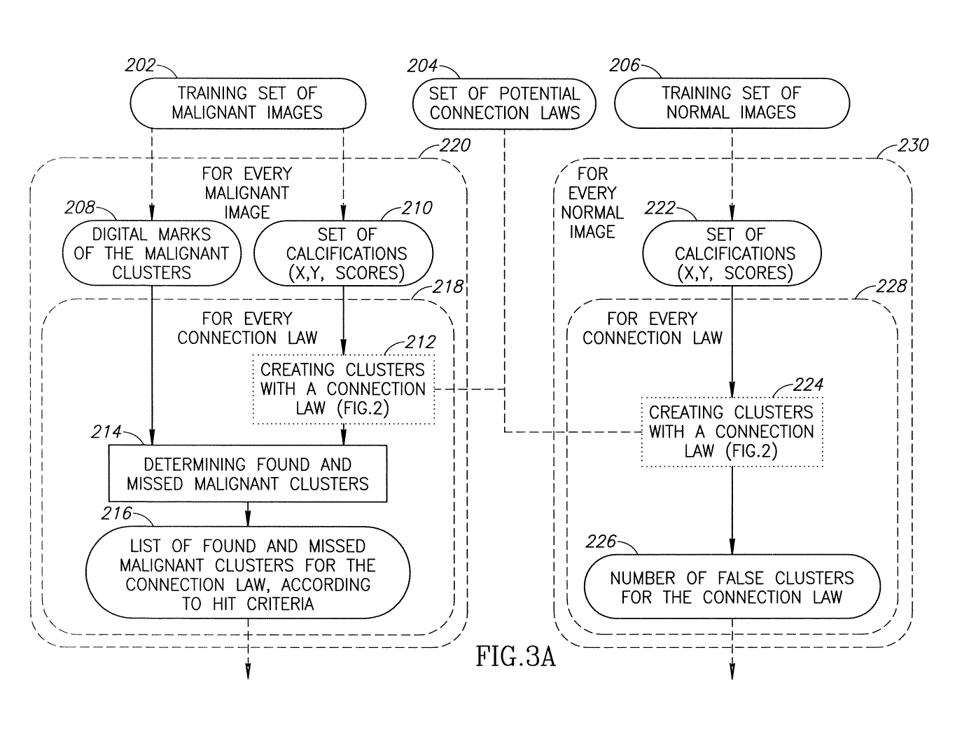

Reference is now made to FIG. 2 where a flow chart is presented showing the method of the present invention for clustering objects. The method includes two recursive processes. In the description that follows the objects described are micro-calcifications located on a mammogram digital image although it should readily be understood by those skilled in the art that they can be any objects requiring clusterization found in a digital image. The micro-calcifications (MCs) in the Figures presented and in the discussion below may also be denoted as “calcifications” or shortened to “calc”. These are all equivalent designations and are not to be deemed as indicating different types of structures.

FIG. 2 indicates that there is first established 102 a set of micro-calcifications (MCs) detected in the image, each MC being given x, y coordinates and a score. The score is a predefined combination of various characteristics of the object as discussed above. With regard to MCs, these include brightness, area, length, shape and any morphological descriptor. They may also include other characteristics not explicitly noted herein.

Groups of calcifications are created 106 which correspond to adjacent image cells. The adjacent cells form a square, typically, but without intending to preclude squares of other sizes, a 1 cm by 1 cm grid.

A determination 108 is made as to whether all calcification groups discussed in conjunction with block 106 are empty. This will normally occur after a variable number of iterations in the recursive process described below.

If all the groups are not empty, the method proceeds by choosing 114 one calcification as the initial reference MC from which a new cluster begins and the reference MC is removed from its group. The step of choosing is typically performed by the processor of the system according to a pre-defined method. However, the result of the clusterization process, i.e. the clusters created, does not depend on the method used for choosing the initial reference MC and, therefore, the initial reference MC may be chosen randomly.

A list is established 118 of all calcifications in the group containing the reference MC and in the eight groups corresponding to its nearest neighbor cells.

A determination 120 is then made as to whether there is a remaining MC in the list established in block 118.

If there are additional MCs in the list, the method requires picking 122 the next MC in the list.

The MC picked in block 122 is tested 124 using a predefined connection law to see if it is connectable to the reference MC. If it is connectable to the reference MC using the connection criteria of the predefined connection law, the MC picked in block 122 is added 126 to the cluster and it becomes the new reference MC. This new reference MC is then removed from its cell's group established in block 106 and the process returns to block 118. Blocks 118, 120, 122, 124, and 126 constitute what in FIG. 2 is called the ‘recursive process-Forward’ path.

If in block 124 the MC last picked from the list established in block 118 is not connectable to the last reference MC, the method requires determining 120 if there are any more MCs in the list which still have not been tested. If the list has not reached its end, blocks 122 and 124 are repeated followed by cycling to the decision block 120 if connectability can not be established. If the end of the list has not been reached and if connectability has been established in block 124, blocks 126, 118 and following blocks are cycled as described above.

If at any point the decision in block 120 indicates that the list is empty and there are no more MCs to be tested, a decision 128 is made as to the presence of an immediate past reference MC. If such an MC exists, the immediate past reference MC is restored 116 and it becomes the new reference MC. A new list of MCs is established 118 listing all the MCs in the group of the new initial reference MC and in the eight groups corresponding to its nearest neighbor cells. This leads to a cycling of blocks 118, 120, 122, 124, and 126 as described previously.

If in decision block 128 no immediate previous reference MC is found, the cluster resulting from the previous steps is added 110 to the list of created micro-calcification clusters (MCCs). The individual MCs in the assembly of MCs forming the created cluster (MCC) are also noted in the list of clusters.

A determination 108 is then made as to whether all the groups created in block 106 are empty. If they are not all empty, the method requires repeating the steps previously described, that is repeating blocks 114, 118, 120, 122, 124, 126, 128, 116 and 110. If it is determined in block 108 that all the groups created in block 106 are empty, the list of clusters discussed in conjunction with block 110 is finalized in block 112.

It should readily be evident that the system for clustering includes a processor which carries out the steps of the method. A display element is in electronic communication with the processor as discussed in greater detail below. Once the list of clusters is complete, block 112 in FIG. 2, the processor may display each listed cluster on a displayed digital image. In some embodiments, this step of displaying may require prior filtering.

Determining an Appropriate Connection Law

The predefined connection law used in decision block 124 of FIG. 2 may be chosen from a set, i.e. family, of connection laws. Every law in the set includes at least two criteria for determining the connectibility of a pair of MCs. These are typically the distance between the two MCs and their pair score value. A pair score (Sᵢⱼ) of a pair of MCs may be chosen in any of many pre-defined ways, for example, the lower individual score of the two MC scores (sᵢ or sⱼ), or the higher individual score of the two MC scores (sᵢ or sⱼ), or the mean score of the two MC scores ((sᵢ+sⱼ)/2), or the weighted mean score of the two MC scores ((asᵢ+bsⱼ)/(a+b)). Without intending to limit the methods of arriving at scores sᵢ and sⱼ for each MC, the scores can be arrived at by using one or a weighted combination of MC characteristics, as discussed previously above.

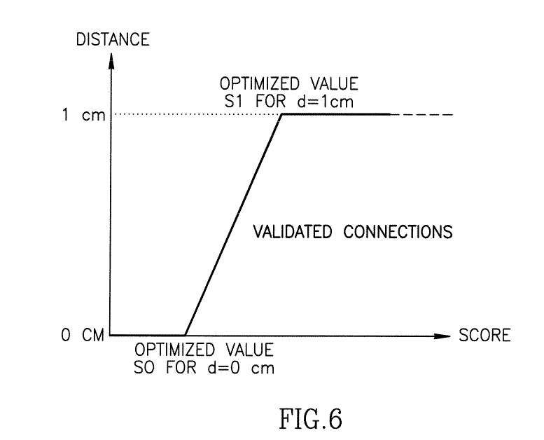

All the laws in the family of possible connection laws (CLs) may be in accord with the graph shown in FIG. 6, to which reference is now made. The connection law (CL) is represented by a curve below which MC pairs can be connected and above which MC pairs can not be connected. It should be remembered that FIG. 6 is only an example of one family of CLs. Other families may also be considered including those having more than two criteria and those suitable for use in more than 2D space.

As can be seen in FIG. 6, the curve is made up of three segments. The lower left segment indicates that no connection can be established below a certain minimal pair score; the upper right segment indicates that no connection can be established above a maximum distance, in FIG. 6 an exemplary 1 cm distance; and the orientation of the middle segment indicates that higher scores allow for connecting more distant MCs.

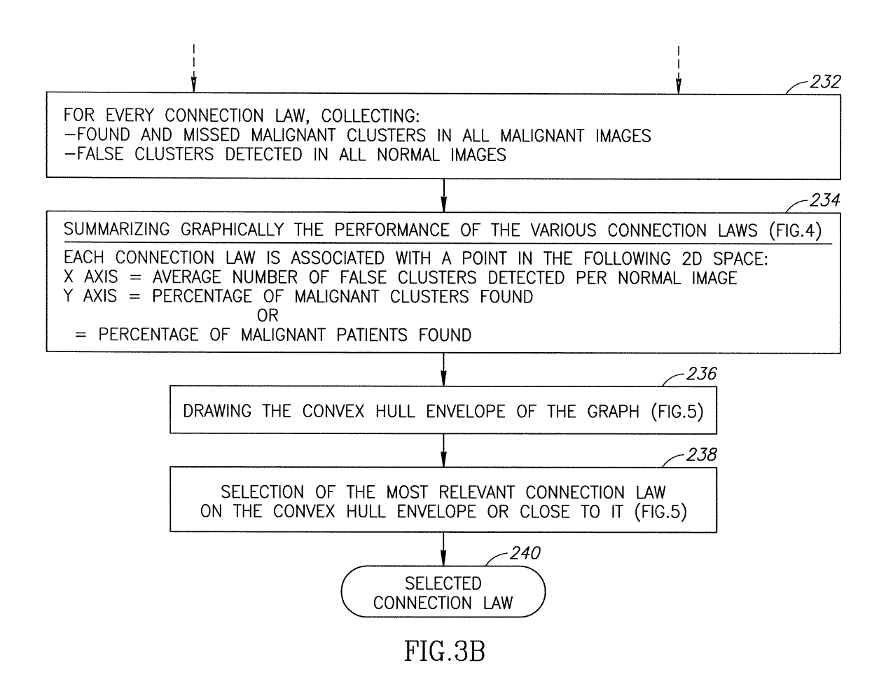

As a consequence, once the maximum distance is defined a priori and the score values (S0, S1) at both extremities of the middle segment of FIG. 6 are chosen i.e. optimized, the CL is fully defined. The various CLs to be used in the optimization process of FIG. 3 described below, will correspond to pair score values S0 and S1 selected from reasonable ranges, in reasonable steps, while the score of the upper segment is above the score of the lower extremity (i.e. S1>S0).

In FIG. 3 to which reference is now made, there is shown another feature of the present invention. FIG. 3 shows a flow chart for evaluating a set of connection laws (CLs) in order to select the best performing CL from a set of CLs that has been previously determined, for example, as described above in conjunction with FIG. 6.

It is impossible to arrive at a clear and unequivocal optimal connection law for clusterization, that is, one that has:
the highest possible sensitivity, i.e. creation of the maximum number of malignant clusters
and also
the highest possible specificity, i.e. creation of a minimum number of false clusters.
   For this reason, the optimization method outlined in FIG. 3, will first identify several connection laws that provide suitable alternative sensitivity/specificity combinations. Based on a pre-existing criterion for sensitivity/specificity balance, the best clinically suited CL will then be selected from the alternatives for use with the method of clusterization described above in conjunction with FIG. 2.

In FIG. 3 training sets are used to determine the optimal connection law from a family of potential connection laws 204. In this optimization procedure, two training sets of known truth values are used: a set of normal images 206 and a set of images which contain at least one malignant lesion 202.

For every image in normal training set 230 there is established 222 a set of i calcifications with every calcification being given xᵢ and yᵢ coordinates and a score sᵢ. Without intending to limit the methods of arriving at a score for each MC, the scores can be arrived at by using one or a weighted combination of the following MC characteristics, also sometimes referred to herein as parameters. These characteristics include brightness, area, length, shape factor, and any morphological descriptor computed according to one or more criteria. This list is exemplary only and is not intended to be exhaustive. The score for each MC may typically be developed by using a weighted expression of the individual characteristics of the MC.

Every connection law 228 in the set of connection laws 204 is used to create 224 clusters for each normal image according to the method discussed above in conjunction with FIG. 2. The number of false clusters in every normal image is determined 226 for each connection law.

In a similar manner, for every malignant image 220 in training set 202 there is established 210 a set of i calcifications with every calcification given xᵢ and yᵢ coordinates and a score sᵢ. The score may be arrived at as described above in conjunction with the MCs in the set of normal images. There are also provided 208 digital markings of each histologically verified malignant cluster found on each image in training set 202.

For every connection law 218 in the set of connection laws 204, clusters are created 212 for each malignant image according to the method discussed above in conjunction with FIG. 2. The number of found and missed malignant clusters in every malignant image is determined 214 for each connection law. Lists of found and missed malignant clusters are prepared 216 for each connection law according to at least one predefined hit criterion. A hit criterion is a criterion according to which we can state that the location and size of a cluster created with a certain CL corresponds to a digital marking of a histologically verified malignant cluster. The digital marking has been provided in block 208.

This is followed by the step of collecting 232 the found and missed malignant clusters in all malignant images and the false clusters detected in all the normal images for every connection law. Clusters which do not contain a predefined minimal number of micro-calcifications are eliminated and not collected.

The collected results 232 may be graphically summarized 234 for the various connection laws. Each connection law is associated with a point in 2-D space with the X-axis equal to the average number of false clusters detected per normal image and the Y-axis equal to the percentage of malignant clusters found or alternatively, but equivalently, the percentage of malignant patients found. The Y-axis therefore essentially reflects the sensitivity of the connection law.

An envelope, such as a convex Hull envelope, may be drawn 236 to envelop the points graphically summarized in block 234. Other types of envelopes may also be used.

A connection law on or close to the envelope may be selected 238 for use in applying the clusterization method of FIG. 2 to MCs in real world digital images of undetermined diseased or normal state. Typically, the selected 240 connection law is one that exhibits the most useful combined values of specificity and sensitivity.

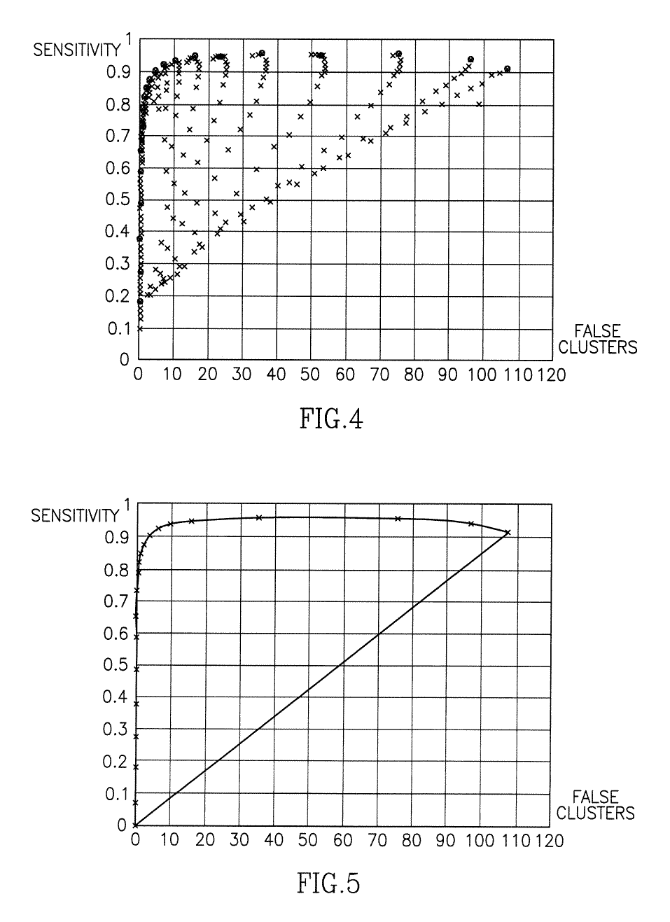

FIG. 4 and FIG. 5 to which reference is now made show the results of blocks 234 and 236 in FIG. 3, respectively. The upper left portion of the curves shows the most suitable CLs, that is the ones that provide the highest sensitivity values for various given specificity values expressed as the number of false clusters created. The CL used in the clusterization method discussed in conjunction with FIG. 2 above is selected among these relevant CLs.

System for Providing and Displaying Micro-Calcification Clusters

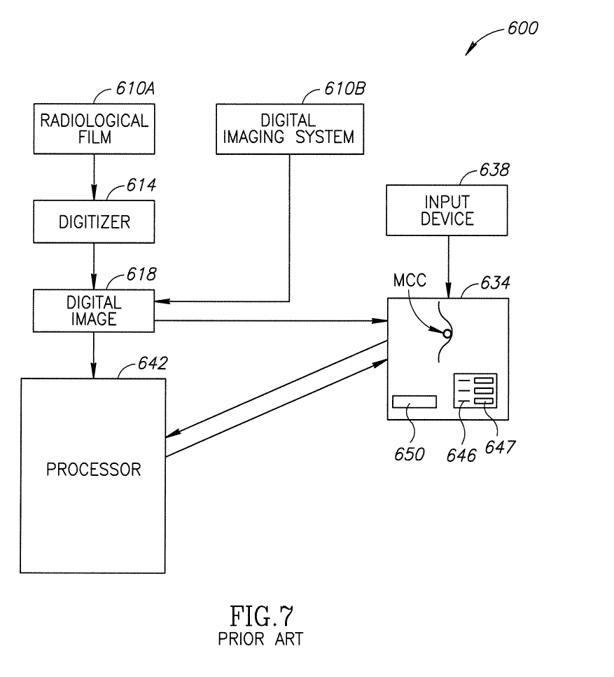

Reference is now made to FIG. 7 which is a schematic illustration of a prior art computer system that may be used to display the MCs and MCCs of a mammogram digital image determined according to the present invention as previously described herein above. The system, generally referenced 600, requires a mammogram provider (610A or 610B) to provide a mammogram. The mammogram provider can be a radiological film system 610A which provides a mammogram in analog format. A digitizer 614 then converts the mammogram into a digital mammogram image 618. Alternatively, the mammogram provider can be a digital imaging system 610B, discussed further below, which provides a digital image 618 directly. No digitization by digitizer 614 is required when a digital imaging system 610B is used. Typically, but without being limiting, the film digitizer 614 is a high resolution charged coupled device (CCD) or laser film digitizer. Digital image 618 is transferred to a display 634 and to a processor 642. It should readily be understood by one skilled in the art that digital image 618 could also be transferred to display 634 from processor 642 after image 618 is first sent to processor 642.

A digital imaging system 610B used as the mammogram provider may be based on any one of many technologies currently available. These, for example, include, but are not limited to, systems based on magnetic resonance imaging (MRI), computed tomography (CT), scintillation cameras and flat panel digital radiography. All these systems provide radiological mammogram images directly in digital format. If required, the digital mammogram can be reformatted into a digitized image compatible with processor 642 prior to its being transferred to processor 642. While some of the above systems, such as MRI and CT produce images that are not usually described as mammograms, since they provide digital images of the breast they are herein considered to be mammogram providers.

Processor 642 can employ any of the many methods described in the literature to identify and compute and classify parameters related to MCs. The output of processor 642 inter alia may be a quantified value for each of several predetermined characteristic parameters of MCs. Methods for use in computing and classifying a plurality of parameters associated with different characterization features of breast abnormalities, including MCs and MCCs, have been described in the patent and technological literature. As discussed above, the method of the present invention may also be used with the described system to effect clusterization.

A user operated input device referenced 638, such as a computer mouse or touch screen, is in electronic communication with display 634 and processor 642. In some embodiments of the present invention, the initial reference MC may be selected by the user using the input device.

In embodiments of the present invention, processor 642 randomly selects the initial reference MC. Processor 642 then processes, that is quantifies and classifies, the predefined parameters related to characterization features of MCs. These parameters can then be used for effecting the clusterization method of the present invention discussed in conjunction with FIG. 2.

Display 634 of FIG. 7 shows a complete breast with a circumscribed computed MCC thereon. Display 634 can also provide an expanded view of the MCC. The MCC shown may be one arrived at by using the method of the present invention shown in FIG. 2. Display 634 may also display additional data in display elements 646, 647 and 650. This may include, but is not limited to, the quantified computed characteristics of the located MCs and/or MCCs. The presentation of such data is discussed in U.S. Pat. No. 7,203,350 to Leichter et al, herein incorporated by reference.

The present invention can easily be extended to the creation of clusters of objects in any space where a score is associated with each object giving some indication of its probability of being a true object that is an object that may form part of the cluster.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for employing a processing system to create clusters of objects in a digital image, said method comprising the steps of:
choosing an initial reference object from a set of available objects in the digital image and removing this object from the set of available objects;
searching the set of available objects for a second object that connects to the reference object according to a pre-selected connection law;
designating the second object as a new reference object and removing it from the set of available objects;
repeating said steps of searching and designating until no connection can be made to any of the remaining available objects in the set or until all objects have been connected;
wherein, said step of repeating includes restoring the immediate previous reference object as the new reference object if no connection can be made to any of the remaining available objects; and
iterating said steps of searching, designating, repeating, and restoring until the set of available objects is emptied or until no previous reference object is left to restore, thereby creating a cluster of objects.

2. A method according to claim 1, further including the step of creating groups of objects from the set of available objects, each group corresponding to the content of an image cell with the image cells being arranged into square grids, the width of each square being equal to a predefined distance, and said step of searching being limited to searching the group containing the reference object plus its surrounding eight nearest neighbor groups.

3. A method according to claim 2, further including the step of selecting another initial reference object and further including the step of cycling through said steps of searching, designating, repeating, restoring and iterating, said steps of selecting and cycling being repeated until all the groups that have been created are empty of available objects, thereby creating a plurality of clusters for the digital image.

4. A method according to claim 3, further including the step of adding all clusters formed by said method to a list of clusters.

5. A method according to claim 4 further including displaying the list of clusters on a display of the processing system after the list of clusters has been filtered according to predefined criteria.

6. A method according to claim 1 wherein the connection law in said step of searching is based on parameters employing the distance between the reference and second objects and a predefined combination of scores related to both the reference and second objects.

7. A method according to claim 1 wherein the connection law only allows for connecting two objects separated by a distance less than or equal to a predefined distance.

8. A method according to claim 1 wherein the objects are micro-calcifications in a mammographic digital image and the clusters of micro-calcifications formed thereby indicate whether the tissue in the image is diseased.

9. A method for establishing an optimized set of connection laws from a preliminary set of connection laws, the optimized set of connection laws to be used for creating clusters of objects in a digital image, said method including the steps of:
providing a set of objects for each image in a training set of malignant images, each object having associated with it spatial coordinates and a score that is statistically related to the probability of the object being a true object, and for each image in a training set of normal images providing a similar, but separate, set of objects;
for each image in the training set of malignant images, providing also a list of the regions containing clusters of known malignant character;
creating clusters of the objects in each image according to the method of claim 1 using a connection law from the preliminary set of connection laws and eliminating from consideration any cluster that does not contain a minimal pre-defined number of connected objects;
determining the average number of false clusters found in the images of the normal training set and the found and missed malignant clusters in each of the images in the malignant training set;
repeating said steps of creating and determining, for each connection law of the preliminary set of connection laws; and
selecting an optimized connection law for use in creating clusters of objects in a digital image, the selected optimized connection law providing an appropriate combination of sensitivity and specificity values for use according to the performance requirements of the user.

10. A method according to claim 9 further including the step of graphically summarizing the performance of each connection law as a point in a 2-dimensional space defined by the percentage of malignant clusters in all the images of the malignant training set correctly determined versus the average number of false clusters detected in the normal training set and the step of drawing an envelope of the points corresponding to the results obtained from the entire preliminary set of connection laws in the graphical summary; and wherein said step of selecting an optimized connection law constitutes selecting a connection law on or near the envelope of the points in the graphical summary.

11. A method according to claim 10, wherein the envelope in said step of drawing is a convex Hull envelope.

12. A method according to claim 9, wherein in each of said steps of providing, each object of the set of i objects is provided with a score sᵢ, determined using a plurality of image characteristics of object i, and each pair of objects, i and j, is given a pair score Sᵢⱼ based on a predefined combination of their individual scores, sᵢ and sⱼ, and a pair distance dᵢⱼ representing the distance between objects i and j.

13. A method according to claim 12, wherein a family of acceptable connection laws is graphically defined in (Sᵢⱼ,dᵢⱼ) space by a broken line such that a pair of objects are connectable when their representation in (Sᵢⱼ,dᵢⱼ) space is located below the broken line and where the broken line is such that:
A first segment extends from (0,0) to (S0,0), S0 being a defined minimal threshold for pair score Sᵢⱼ;
A second segment goes from (S0,0) to (S1,dmax), S1 being a defined second pair score value and dmax being the distance above which no connection is allowed; and
A last infinite segment starting from (S1,dmax) and continuing horizontally toward (∞,dmax).
